(19) United States
(12) Patent Application Publication
(10) Pub. No.: US 2015/0064664 A1
(43) Pub. Date: Mar. 5, 2015

(54) Method And Apparatus For Teaching The Pronunciation of Alphabet Characters Of An Unfamiliar Language

(71) Applicant: Danimar Media LLC, Brookline, MA (US)

(72) Inventor: Marisa Gobuty, Sarasota, FL (US)

(73) Assignee: Danimar Media LLC, Brookline, MA (US)

(21) Appl. No.: 14/011,184

(22) Filed: Aug. 27, 2013

(51) Int. Cl. G09B 19/08

(52) U.S. Cl. CPC G09B 19/08
USPC 434/157

(57) ABSTRACT

Method and apparatus for teaching a student the pronunciation of alphabet characters of an unfamiliar language include providing a group of distinct sequential narrative media segments, each narrative media segment including a partial transliterated narrative text comprising words of a base language known to the student formed by base characters of a base alphabet, and wherein a number of target characters comprising a subset of the target alphabet are substituted in the text for corresponding base characters of the base alphabet, the sequential media segments containing successively increasing numbers of target characters of the target alphabet substituted for corresponding base characters of the base alphabet; and displaying each narrative media segment to the student sequentially.

### BACKGROUND OF THE INVENTION

The present invention relates generally to methods and apparatus for use in teaching a student a new or target language whose alphabet is different from an alphabet of a language with which the student is already familiar and, more particularly, to methods and apparatus for teaching the pronunciation of characters, for example, letters, of an unfamiliar alphabet of an unfamiliar language.

By way of background, there are several languages in use throughout the world that are written using different alphabets, i.e., respective sets of characters or symbols, for example, letters, that differ from those of the alphabets of other languages. An alphabet is a set of characters or symbols, sometimes called graphenes, e.g., letters, that are conventionally used in writing a language and which generally (although not always) represent respective basic sounds (called phonemes) in the spoken form of the language. For example, different respective alphabets are used in writing the Greek, Cyrillic (various Slavic languages), Arabic, Hebrew and English (Latin) languages.

In teaching a language whose alphabet is different from an alphabet of a language with which the user is familiar, one of the first steps is for the user to learn what sound is represented by, i.e., the pronunciation of, each character or symbol of the alphabet of the unfamiliar language to be learned. Most often, this is done by comparing a character of the alphabet of the unfamiliar language with a corresponding character of the alphabet of a known language that has the same or similar sound or pronunciation. Generally, there is substantial correspondence in pronunciation between certain corresponding characters of different languages (in part due to a common ancestry of the languages), although some differences in sound often exist. In learning the pronunciation of characters of an unfamiliar alphabet, a user may consult printed or online literature showing an unfamiliar character along with a term written in characters of a known language “sounding out” the pronunciation of the character. For example, charts on which one or more known characters, e.g., letters of a known language, are printed alongside characters or of an unfamiliar language that have the same or similar pronunciation are common. Another method of learning the pronunciation of unfamiliar characters is to visit interactive websites or listen to pre-recorded audio media that provide the pronunciation of characters in audible form. While these methods are generally useful, they are often tedious and boring making it difficult for language students and others, especially children, to learn the pronunciations of all of the characters of the unfamiliar language in a relatively simple, effective and enjoyable manner.

### SUMMARY OF THE INVENTION

It is an object of the present invention to provide new and improved methods and apparatus for teaching the sounds, i.e., the pronunciation, of the letters and other characters of an alphabet of an unfamiliar language, e.g., a foreign language.

It is another object of the present invention to provide new and improved methods and apparatus for teaching the pronunciation of letters and characters of an unfamiliar language which is simple, effective and enjoyable.

Briefly, in accordance with the present invention, these and other objects are attained by providing methods and apparatus incorporating what is sometimes referred to herein as reverse partial transliteration. Generally, transliteration refers to substituting for each of the characters of a word in one language the corresponding characters of another language which have the same or similar sounds so that the pronunciation of the transliterated word sounds the same. Conventionally, transliteration is used for the purpose of enabling a user to pronounce a word written in an unfamiliar alphabet of a foreign language. In such conventional transliteration, the unfamiliar characters, for example, letters of a foreign word, are replaced with corresponding characters of a known language. Generally, the intended purpose of such conventional transliterations, as noted above, is to enable the user to pronounce the foreign words even though the user may not know their meaning.

The methods and apparatus for teaching the sound or pronunciation of unfamiliar characters of an unfamiliar language in accordance with the invention are practical applications of a reverse and partial form of the conventional transliteration described above. As used herein, the term “reverse partial transliteration” refers to replacing instances of at least one, but not all, of the known characters of a word in a known language by corresponding unfamiliar characters of an unfamiliar language whose pronunciations are to be learned. The number of known characters or letters of the word in the known language that remain after the substitution is chosen such that the reverse partial transliterated word is readily apparent to the user despite the substitution of the unfamiliar characters, so that the pronunciation of the foreign characters that have replaced one or more (but not all) of the characters of the known language will also be readily apparent to the user from their sounds in the word.

As used herein, the term “base language” is used to refer to a language that is known or familiar to the student, such as the student's native language. The words of text written in the base language are formed using “base characters,” e.g., letters, of a “base alphabet.” On the other hand, the term “target language” is used herein to refer to a language with which the student is not familiar, such as a foreign language. Words are formed in the “target language” using “target characters,” e.g., letters, of a “target alphabet” which are different from the letters of the base alphabet. It is the teaching of the sound or pronunciation of the target characters that is the object of the present invention.

In accordance with one aspect of the invention a group of distinct sequential narrative media segments is provided, each narrative media segment including a reverse partial transliterated text comprising words of a base language formed by base characters of a base alphabet in which at least one, but not all, of the base characters in the text are replaced by corresponding target characters whose pronunciations are to be learned by the student. The number of different base characters replaced in each narrative media segment is chosen such that the user, based on his/her age and proficiency, will still recognize the reverse partial transliterated words despite the substitution of the target characters, so that the pronunciation of the target characters that have replaced the one or more (but not all) of the base characters is readily apparent to the user from the sound that they represent in the words. The narrative texts of each sequential narrative media segment may be a separate story or may be one part of the same story as the narrative of the other media segments.

The sequential narrative media segments respectively contain successively additional target characters substituted for corresponding base characters of the words of the text. For example, if English is the base language and Hebrew is the target language, i.e., it is the pronunciation or sound of Hebrew characters of the Hebrew language which is to be taught, the first media segment may contain text whose words are written in English letters, but where the English letters a, b, and v are replaced by corresponding target characters of the Hebrew language, namely, [symbol] , and [symbol] . The user will still recognize the English word from the context of the other English letters in the word, and from the context of the other words in the text. The next sequential narrative media segment may contain text whose words are written in English characters, but where in addition to replacing the letters a, b, and v, with [symbol] , and [symbol] , the English letters h, d, and g are replaced by corresponding Hebrew characters [symbol] , and [symbol] . The text of each successive sequential narrative media segment likewise has the English characters that were replaced in prior media segments also replaced in it, as well as additional Hebrew characters replacing additional corresponding English characters. Before using a next narrative media segment in accordance with the invention, the student has learned the pronunciation of the Hebrew characters which replaced English letters in the previous narrative media segments sufficiently to sound out the words of the text in the next narrative media segment. Sufficient narrative media segments may be provided such that eventually a narrative media segment is provided in which substantially all of the English letters of the words in the text are replaced by corresponding Hebrew characters.

In accordance with another aspect of the invention, a group of distinct sequential review/activity media segments are provided which correspond to respective distinct sequential narrative media segments. Each review/activity media segment includes partial transliterated words of the base language constituting at least one student activity, wherein a number of target characters corresponding to the target characters substituted in the text of a corresponding narrative media segment are substituted in the words constituting the at least one activity of a respective corresponding review/activity media segment. After displaying a particular narrative media segment to the student, and prior to displaying the next sequential narrative media segment to the student, a review/activity media segment which corresponds to the particular narrative media segment already displayed to the student is displayed to the student. The student can review the pronunciation of the target characters he or she had just learned from the previous corresponding narrative media segment by completing the activities on the review/activity media segment.

### DETAILED DESCRIPTION OF THE DRAWINGS

A more complete appreciation of the invention and many of the attendant advantages thereof will be readily appreciated from the following description when taken in conjunction with the accompanying drawings in which:

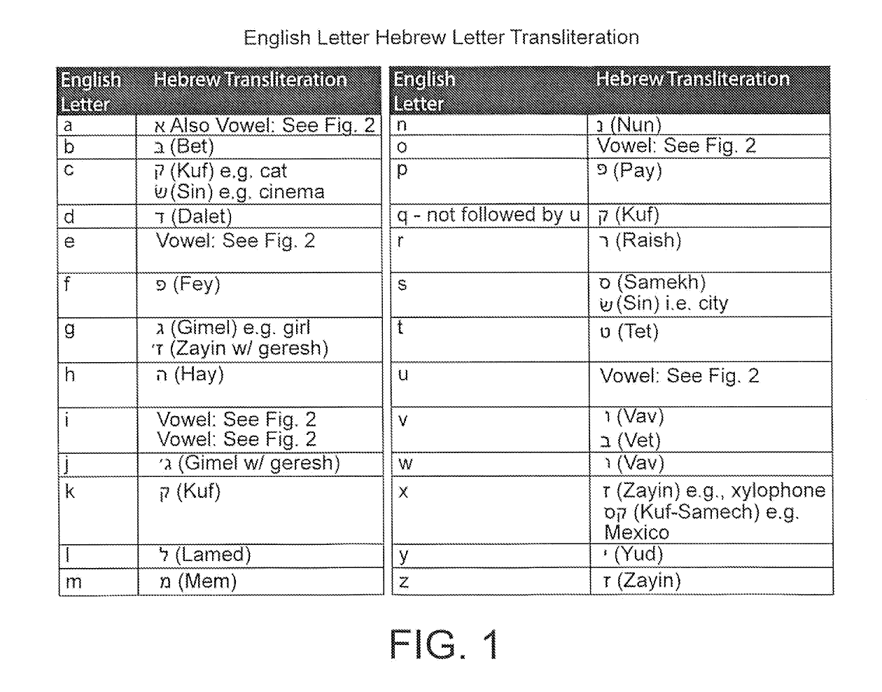

FIG. 1 is a chart showing Hebrew letter transliterations of corresponding English letters;

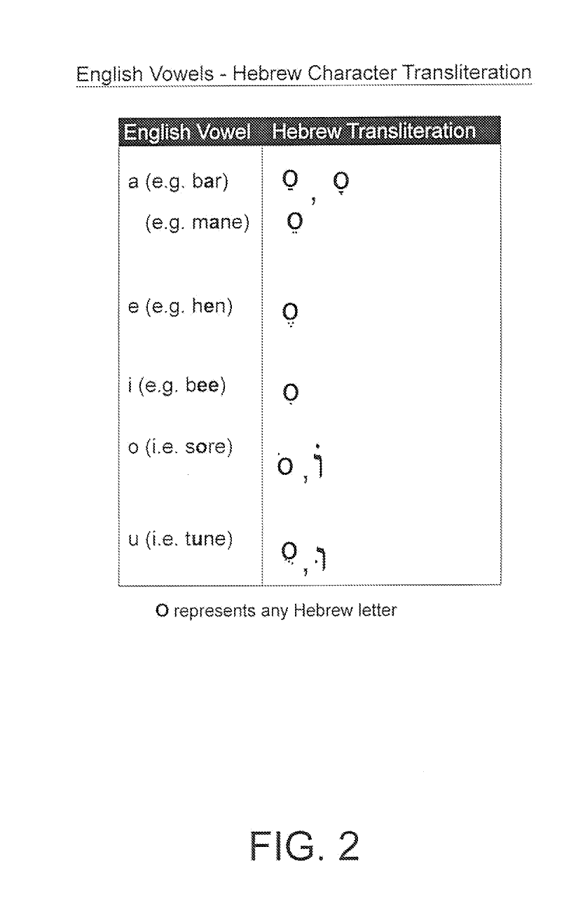

FIG. 2 is a chart showing Hebrew character transliterations of English vowels;

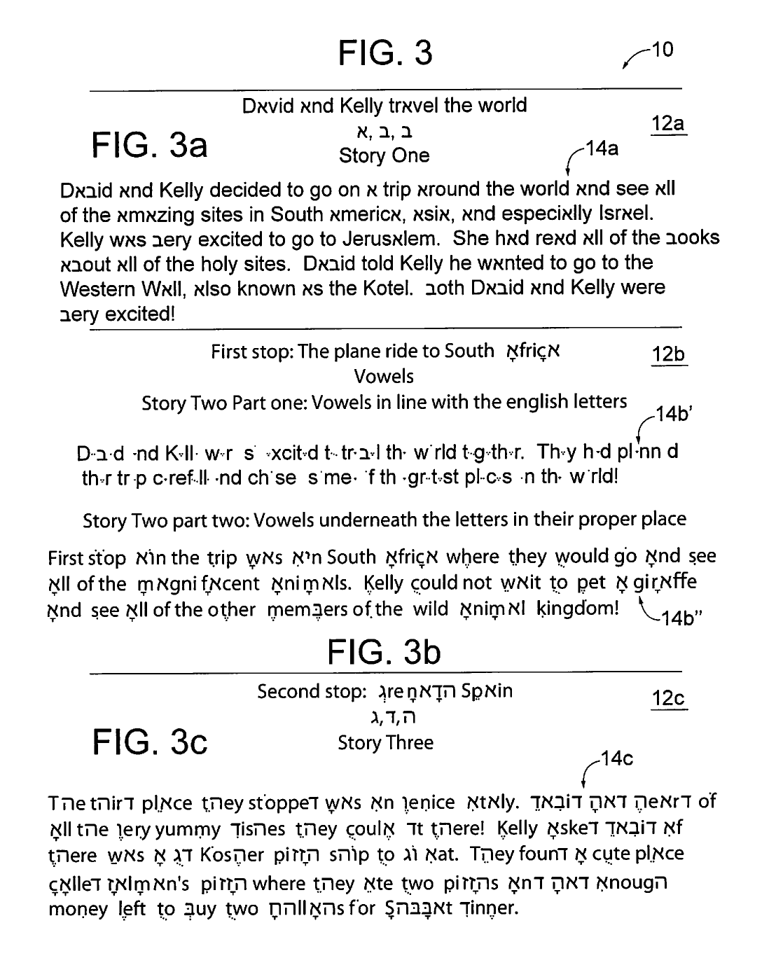

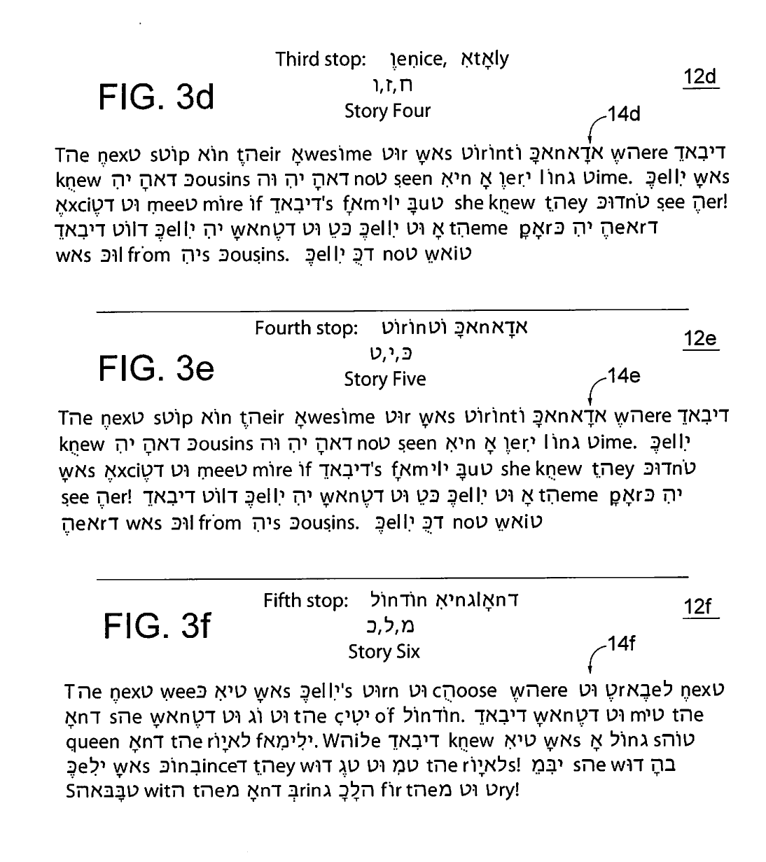

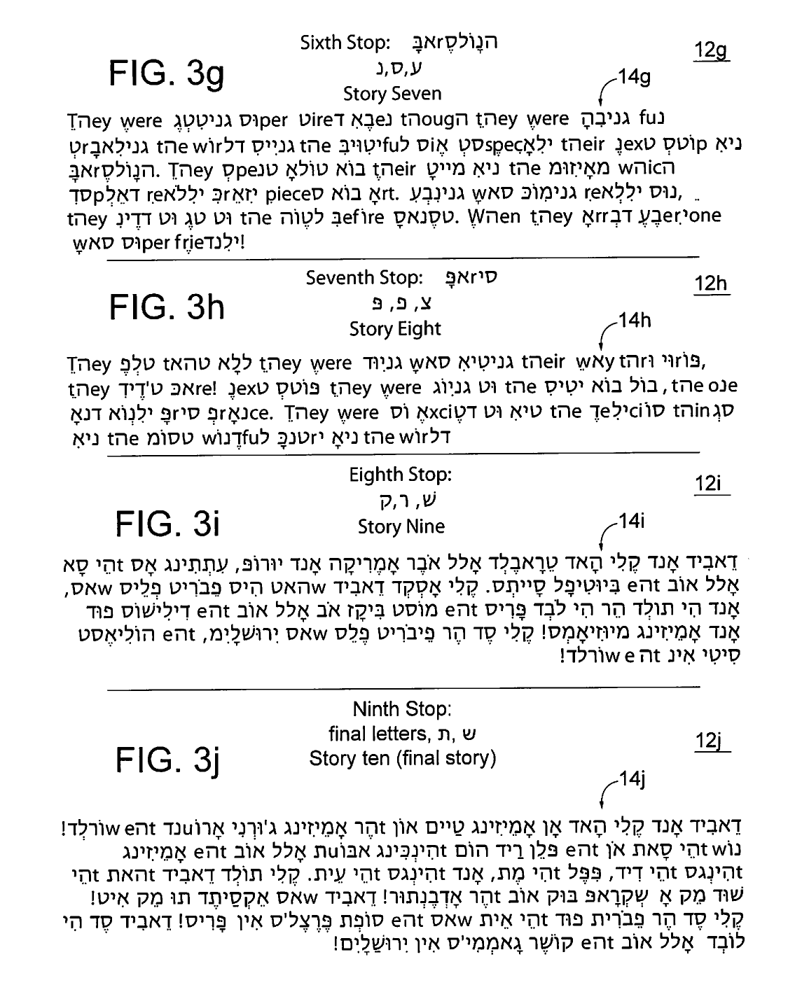

FIGS. 3a-3j are examples of distinct sequential narrative media segments forming a group, each narrative media segment including a reverse partial transliterated text in English in which Hebrew letters and/or characters are substituted for corresponding English letters, and wherein successive media segments contain additional Hebrew letters and/or characters substituted for corresponding English letters;

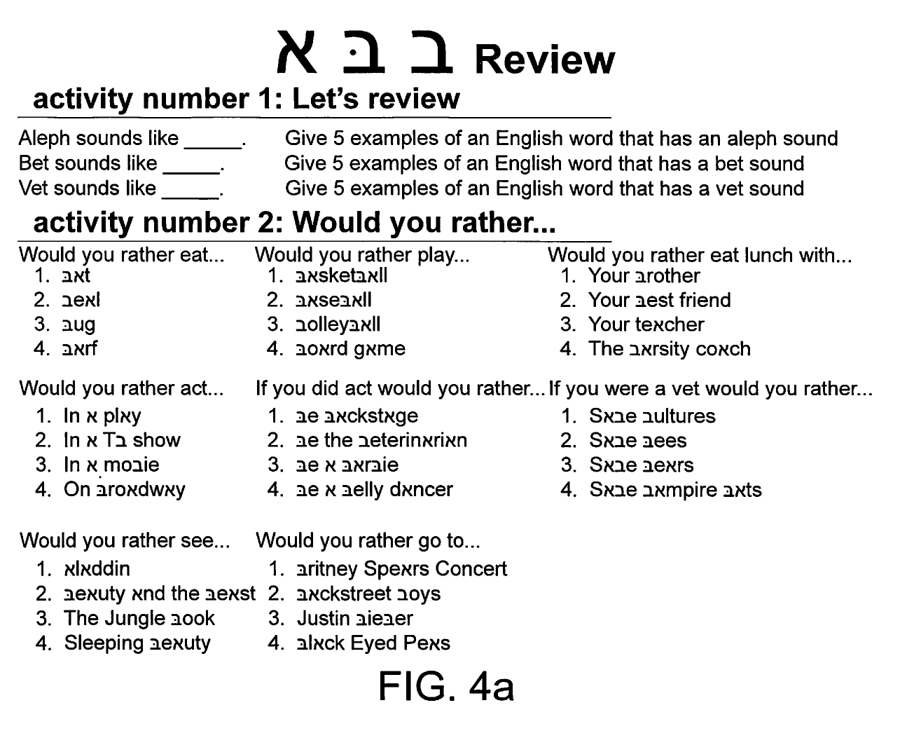

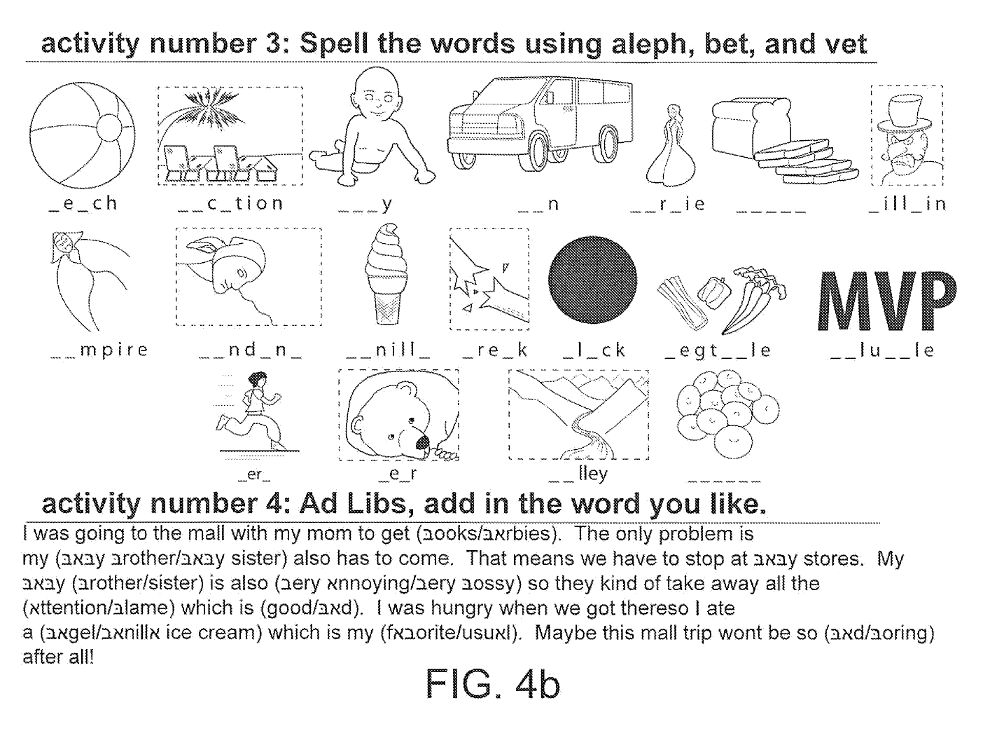

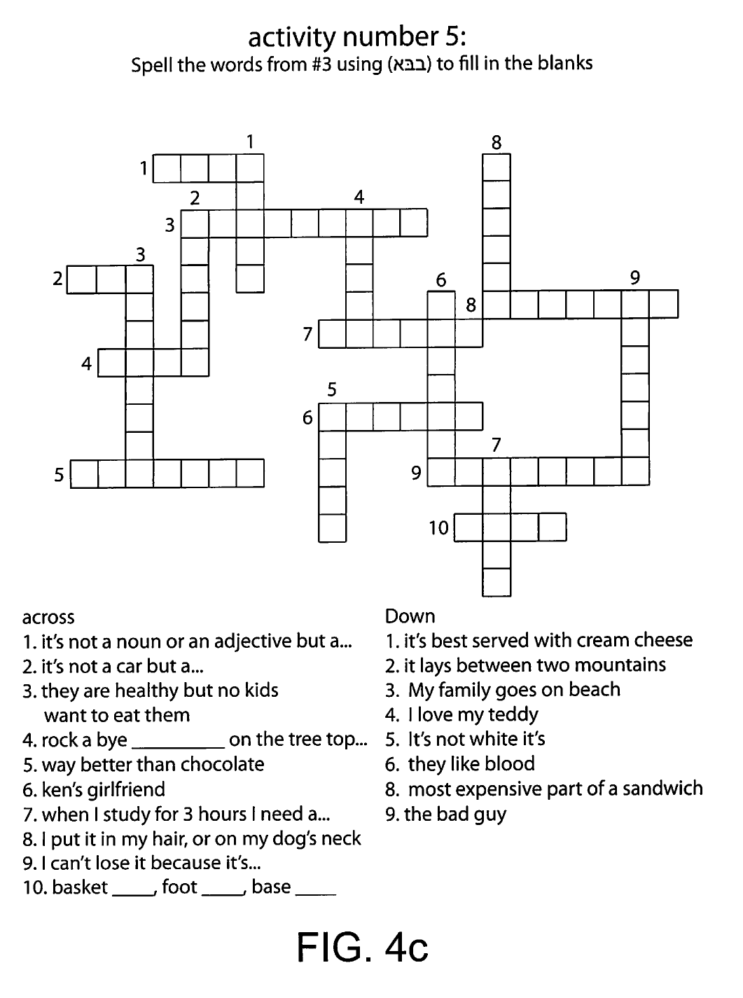

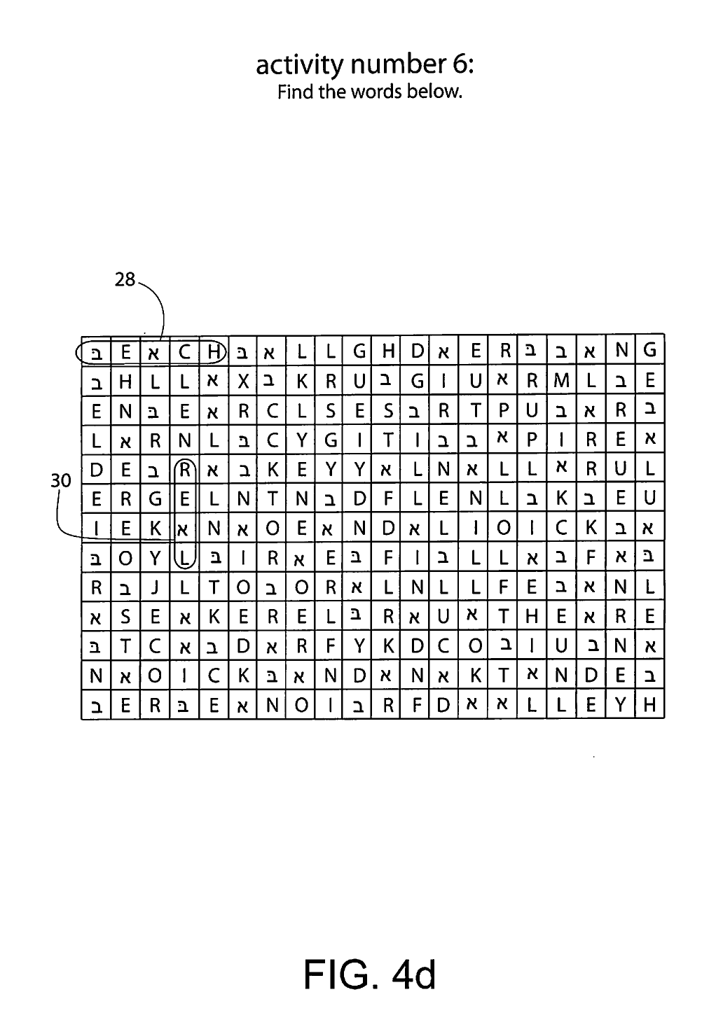

FIG. 4 is an example of a distinct sequential review/activity media segment which is part of a group and which corresponds to a respective narrative media segment; and

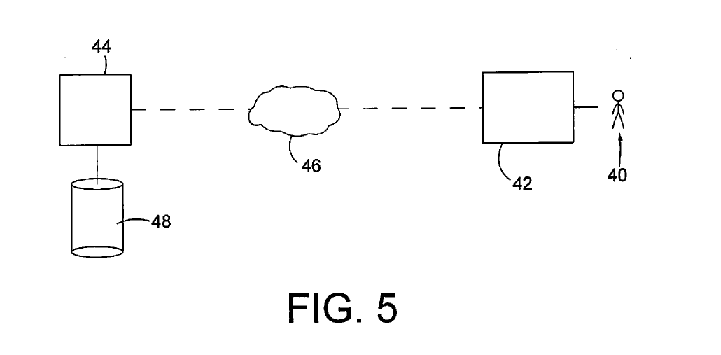

FIG. 5 is an example of apparatus for teaching the pronunciation of target letters and/or characters in accordance with the invention.

### DETAILED DESCRIPTION OF THE PREFERRED EMBODIMENTS

Referring now to the drawings where like reference characters designate identical or corresponding parts throughout the several views, the invention will be described in connection with an embodiment in which the pronunciation of Hebrew letters and characters (target characters) is taught to a student familiar with the pronunciation of letters of the English language (base characters). However, it is understood that other embodiments of the invention are possible, for example, the invention may be applied in connection with teaching the pronunciation of Arabic letters to a person familiar with the pronunciation of the letters of the Greek alphabet.

FIG. 1 is a chart showing Hebrew letter transliterations of corresponding English letters (consonants) according to one scheme, it being understood that there is no standard list of transliteration schemes. The letters of the Hebrew alphabet generally correspond to consonants of the English alphabet and, as discussed below, vowels in the Hebrew language are represented by other characters, called Niqquid, which are shown in the chart of FIG. 2 alongside corresponding English vowels.

Referring to FIG. 3, ten distinct sequential narrative media segments 12a-12j are illustrated in FIGS. 3a-3j respectively. The ten narrative media segments constitute a group, generally designated 10. Each media segment 12a-12j (expect possibly the last media segment 12j) includes a reverse partial transliterated narrative text 14a-14j respectively, comprising English language words written in the English alphabet. At least one, but not all (except possibly in the last narrative media segment 12j) of the English letters in the texts 14a-14j are replaced by corresponding Hebrew letters and characters whose pronunciations are to be learned by the student. The number of different English letters replaced in each media segment is chosen such that the student, based on his or her age and proficiency, will still recognize the reverse partial transliterated English words despite the substitution of the Hebrew letters and characters.

The narrative sequential media segments 12a-12j contain successively additional Hebrew letters substituted for corresponding English letters of the words of the texts 14a-14j. In the illustrated embodiment, three Hebrew letters are substituted for corresponding English letters in the text 14a of the first narrative media segment 12a. Hebrew characters representing vowels are added in the text 14b of the second narrative media segment 12b replacing corresponding English vowels. In the illustrated embodiment both Hebrew and English vowels are included to make the words easier to recognize until more letters are learned. For example, the English letter “i” is retained until the Hebrew letter “ [symbol] ” (yud) is learned. Three additional Hebrew letters replace corresponding English letters in each of the next successive sequential narrative media segments 14c-14i, and the final two Hebrew letters replace corresponding English letters in the last sequential narrative media segment 12j, which may be considered to constitute a substantially complete reverse transliteration. Each of the discrete narrative media segments may be the subject of a separate lesson for the user and it has been found that for children 10-12 years of age whose native language is English, the pronunciation of three additional transliterated letters in each successive lesson can be effective. In the illustrated embodiment, each of the narrative texts 14a-14j of the narrative media segments 12a-12j are part of a single story about David and Kelly. This feature adds to the enjoyment of the learning experience. Each of the narrative texts 14a-14j illustrated in FIGS. 3a-3j may represent only a portion of a larger narrative text which is desirably included in each respective narrative media segment 12a-12j. For example, a narrative text of each narrative media segment containing between about 200 and 1200 words is effective.

Referring specifically to the narrative media segment 12a illustrated in FIG. 3a, the transliterated text 14a comprises English words formed of English letters with the three English letters a, b and v replaced by their corresponding Hebrew transliterations, [symbol] , and [symbol] . In the illustrated embodiment, three different English characters are replaced in the first narrative media segment 12a since it has been found that the intended age group will readily recognize the reverse partial transliterated words despite the substitution of the transliterated Hebrew letters in view of the remaining English letters in the word as well as the context of other words used in the same or other sentences. Once the partially transliterated word is recognized, the pronunciation of the Hebrew letters becomes apparent from the sounds that they represent in the partial transliterated word. For example, the word “ [symbol] ” is immediately recognized as “both,” not only from the English letters “oth” in the word itself, but also from the context of the other words in the sentence in which the word appears. Thus, the student learns that the pronunciation of a [symbol] is the same as a b. The correct pronunciations of the Hebrew letters is reinforced throughout the narrative text of the first narrative media segment through the consistent substitution for the corresponding English letters. For example, the letter [symbol] also appears in the words “ [symbol] ” and “ [symbol] ,” which the user will recognize as “books” and “about.” The pronunciation of the Hebrew letter [symbol] as corresponding to the pronunciation of the English letter b is thus repeated throughout the text of the first narrative media segment sufficiently to be learned by the student after reasonable study or review.

Regarding the pronunciation of the [symbol] , this letter is actually silent in the Hebrew language but corresponds with the English letter a from the standpoint of being the first letter of the alphabet and in sometimes used to indicate the letter “a” in non-hyphen initial word positions. For this reason, the English letter “a” is replaced by an [symbol] in the text of the various narrative media segments.

Referring to FIGS. 1 and 2, the letters of the Hebrew alphabet include only consonants. The vowel sounds are represented in the Hebrew language mainly by symbols or characters called “Niqqud” as well as by the letter “vuv” with a holom [symbol] and a “vuv” with a shuruk [symbol] (FIG. 2). Referring to FIG. 3b, two narrative text portions, designated 14b′ and 14b″, are included in the narrative media segment 12b. The text portion 14b′ of narrative media segment 12b comprises English words formed of English letters with the English letters a, b and v replaced by [symbol] , and [symbol] (continuing from the first narrative media segment) and wherein additionally the Hebrew symbols or characters representing vowel sounds are inserted in line with the English letters replacing corresponding English vowels. For example, the word “ [symbol] ” would be readily recognized as “David” since the student is familiar with the pronunciation of the English letters D (and d) and the pronunciation of the Hebrew letter “ [symbol] ” (from reviewing the first narrative media segment 12a). It will be apparent to the student from the recognition of the word “David” that two horizontally adjacent dots “..” is pronounced with an “ay” sound (e.g., mane) and that a single dot “.” is pronounced with an “i” sound (e.g., bee). In the text portion 14b″, the Hebrew vowel characters are situated underneath the English and Hebrew letters which is their proper place in the Hebrew language. Using the vowel characters in line with the English letters in the narrative text portion 14b′ enables the student to understand the vowel sounds before placing them in their proper positions.

In the narrative text 14c of the third narrative media segment, 12c, Hebrew letters [symbol] and [symbol] are added (along with the previously substituted Hebrew letters) and replace English letters, g, d and h. In the narrative text 14d of the fourth narrative media segment 12d, Hebrew letters [symbol] and [symbol] , are added along with the previously substituted Hebrew letters, and replace English letters v, z, ch. In the narrative text 14e of the fifth narrative media segment 12e, Hebrew letters [symbol] , and [symbol] are added along with the previously substituted Hebrew letters, and replace English letters t, y and c. In the narrative text 14f of the sixth narrative media segment 12f, Hebrew letters [symbol] and [symbol] are added along with the previously substituted Hebrew letters and replace English letters ch, l and m. In the narrative text of 14g of the seventh narrative media segment 12g, the Hebrew letters [symbol] and [symbol] are added along with the previously substituted Hebrew letters and replace English letters n, s and a silent letter (depends on vowel). In the narrative text 14h of the eighth narrative media segment, 12h, Hebrew letters [symbol] and [symbol] are added along with the previously substituted Hebrew letters and replace English letters p, f and tz. In the narrative text 14i of the ninth media segment 12i, Hebrew letters [symbol] and [symbol] are added along with the previously substituted Hebrew letters, and replace English letters k, r and sh. Additionally, the narrative text 14i of the ninth narrative media segment (and the following narrative media segments) reads from the right towards the left which is the proper direction for the Hebrew language. Finally, in the narrative text 14j of the tenth and last media segment 12j, Hebrew letters [symbol] and [symbol] are added along with the previously substituted Hebrew letters and replace English letters t and s.

The group of successive narrative media segments thus constitute a program for a student to learn the pronunciation of all of the target characters of a target alphabet of a target language, such as Hebrew. The narrative texts of the narrative media segments preferably form parts of a single story. Each successive part is designed to accommodate the student's proficiency acquired through review of previous narrative media segments. Each narrative media segment preferably is part of a particular lesson devoted to teaching the student the pronunciation of certain additional target characters that are substituted for base characters in that narrative media segment. At the same time, the particular narrative media segment reinforces the student's knowledge of the pronunciation of target characters that were substituted for base characters in prior narrative media segments which the student has already reviewed. As the difficulty of the narrative media segments increases, i.e., as a greater number of target characters are substituted, the narrative text may be split into parts to shorten them so that a more difficult narrative media segment may be the focus of several different lessons.

A teaching arrangement in accordance with the invention is also advantageous in view of the reading comprehension element which is inherent. While most methods of teaching students to learn the pronunciation of target characters do not include a reading comprehension element since the student does not understand the foreign language, the practice of the present invention builds confidence through the student's understanding of the words of the narrative text of the narrative media segments since those words are recognizable from the use of base language characters along with target characters. Students, therefore, become more confident in their understanding of the pronunciation of the target characters. Additionally, the students become confident that their pronunciation is correct because of the ability to check the sounds with the English words. A student will know if a target character is being pronounced incorrectly because the base language word will not be recognized.

In accordance with another aspect of the invention, a group of distinct sequential review/activity media segments 20 (only one shown in FIG. 4) are provided which correspond to respective distinct sequential narrative media segments 12a-12j. Each review/activity media segment 20 includes partial transliterated words of the base language constituting at least one student activity, wherein a number of target characters corresponding to the target characters substituted in the text of a corresponding narrative media segment 12 are substituted in the words constituting the at least one activity of a respective corresponding review/activity media segment. After displaying a particular narrative media segment 12 to the student, and prior to displaying the next sequential narrative media segment 12 to the student, a review/activity media segment 20 which corresponds to the particular narrative media segment 12 already displayed to the student is displayed to the student. The student can review the pronunciation of the target characters he or she had just learned from the previous corresponding narrative media segment by completing the activities on the review/activity media segment. The term “activity” is used herein to denote an exercise that involves direct or active experience or action by the student in addition to passive review.

Referring to FIG. 4, a review/activity media segment 20a is illustrated which includes various activities for a student which are designed to reinforce the student's knowledge of the pronunciation of certain Hebrew letters which may have been acquired using a corresponding one of the group of sequential media segments described above. In particular, the review/activity media segment 20a includes activities intended to reinforce the student's knowledge of the pronunciation of the Hebrew letters [symbol] , and [symbol] which a student may have acquired from reading the partial transliterated text of the corresponding narrative media segment 12a shown in FIG. 3a. Advantageously, the student is provided with the activities included on review/activity media segment 20a soon after reading the text of narrative media segment 12a.

Several of the activities included on media segment 20a are particular applications of reverse partial transliteration discussed above. In particular, activity 2 asks the student a series of “would you rather . . . ” questions in English and, for each question, four possible answers are listed, each answer being written in reverse partial transliteration in which the Hebrew (target) characters, [symbol] , and [symbol] , replace corresponding English (base) characters a, b and v. For example, under the question “would you rather eat . . . ” are listed: 1. [symbol] 2. [symbol] 3. [symbol] 4. [symbol] . Based on the student's knowledge of the pronunciation of the English characters and the pronunciation of [symbol] , and [symbol] , learned from the student's review of the narrative media segment 12a, the student will recognize that the correct answer is number 2, “ [symbol] ” or “veal.”

Referring to activity 4, the student is asked to “add in the word you like” in sentences written in English (the base language) but in which two choices of a reverse partial transliterated word or phrase, in which [symbol] , and [symbol] are replaced by a, b and v are provided from which the student can choose. For example, activity 4 includes the sentence “I was going to the mall with my mom to get ( [symbol] ). Again, the student's knowledge of the pronunciation of the [symbol] , and [symbol] , from reading narrative media segment 12a and his or her knowledge of the pronunciation of the English characters, enables the student to recognize the two possible choices as “books” or “Barbies.” The sentences in activity 4 are preferably parts of a single story so that the student can creatively participate in writing his or her own story while reinforcing his or her knowledge of the pronunciation of the Hebrew characters.

Activity 6 of the review/activity media segment 20a is another example of the application of reverse partial transliteration in teaching and/or reinforcing the knowledge of the pronunciation of the Hebrew letters [symbol] , and [symbol] . Activity 6 comprises a grid or matrix of English letters along with the Hebrew letters [symbol] , and [symbol] , arranged in rows and columns. Based on his or her knowledge of the pronunciation of the English letters as well as the pronunciation of the Hebrew letters [symbol] , and [symbol] , obtained from review of the narrative media segment 12a, a student is asked to find partial transliterated English language words embedded in the matrix. For example, the student will recognize the word, designated 28, in the first row written as [symbol] [symbol] as “beach,” and will recognize the word designated 30 in the fourth column written as [symbol] as “real.” Activity 6 reinforces the student's knowledge of the pronunciations of [symbol] , and [symbol] by asking the student to sound out strings of characters which incorporate both base (English) letters and well as target (Hebrew) letters and identifying English words known to him or her. Identifying an English word including the target letters assures the student that the pronunciation given to the target letters is the correct one.

The review/activity media segment 20a described above (shown in FIG. 4) provides examples of discrete activities comprising particular applications of reverse partial transliteration of words of a base language in order to teach and/or reinforce a student's knowledge of the pronunciation of certain target letters of a target alphabet, in this case, [symbol] , and [symbol] . A separate discrete review/activity media segment is provided for each group of new target characters whose pronunciations are to be learned by the student. The base characters replaced in the word or words of each review/activity segment 20a-20j correspond to the base characters replaced in the narrative texts 14a-14j of the narrative media segments 12a-12j. After displaying a particular narrative media segment 12a-12j to the student for his or her review, a corresponding review/activity media segment 20a-20j is then displayed to the student for review to reinforce the knowledge of the pronunciation of the corresponding target characters learned in the respective narrative media segment.

In a method according to the invention, a first step includes providing a first narrative media segment including a partial transliterated narrative text comprising words of a base language known to a student formed by base characters of a base alphabet wherein a first number of target characters of a target alphabet are substituted in the text for corresponding base characters of the base alphabet. A second step includes providing a second narrative media segment including a partial transliterated narrative text comprising words of the base language formed by base characters of a base alphabet wherein a second number of target characters comprising the first number of target characters plus additional target characters are substituted in the text for corresponding base characters of the base alphabet. Similarly, a third step includes providing a third narrative media segment including a partial transliterated text comprising words of the base language formed by base characters of the base alphabet wherein a third number of target characters comprising the second number of target characters plus additional target characters are substituted in the text for corresponding base characters of the base alphabet. Additional steps providing additional sequential narrative media segments are performed in a like manner. According to the method, each of the first, second, third, etc. narrative media segments are subsequently displayed to a student in a sequential manner. In each case, a next sequential media segment is displayed to the student only after the student has read and studied the narrative text of the previous media segment sufficiently to learn or become familiar with the pronunciation of the number of target characters substituted in that previous media segment.

In another embodiment, before displaying a next sequential narrative media segment to the student, a corresponding review/activity media segment is displayed to the student for his review to reinforce the knowledge of the pronunciation of the target letters included in the prior sequential narrative media segment.

In another embodiment, each sequential narrative and review/activity media segment is provided on sheet material, such as paper, and displayed to the student in sheet material form.

Referring to FIG. 5, in still another embodiment, a student 40 may access the sequential narrative and review/activity media segments through a desktop computer 42. The computer 42 may access a host processor, which may be incorporated in a desktop computer 44, through a network 46, such as the Internet. The media segments are electronically stored in a content database 48 coupled to the host computer 44. A teacher may operate the host computer 44 and cause a desired narrative and/or review/activity media segment to be displayed to the student 40 on the desktop computer 42. The teacher may be in voice communication with the student while the student reviews a particular media segment in order to facilitate the student's understanding.

In one embodiment, the student and teacher will sign onto a voice-over-IP service such as Skype® and a screen sharing application such as Join Me® is utilized by which a student will share the teacher's screen. At points throughout the lesson, the teacher will control the student's screen and at other points in the lesson, the student can control the teacher's screen and be able to write and actively participate with the shared material. Using the group of sequential narrative media segments, preferably supported by the review/activity media segments, which are also electronically stored in the content database 48, a student can learn the pronunciation of several target characters, such as about three target characters, per lesson.

Obviously, numerous variations and modifications of the present invention are possible in the light of the above teachings. It is therefore to be understood that within the scope of the claims appended hereto, the invention may be practiced otherwise than as specifically disclosed herein.

1. A method of teaching a student the pronunciation of target characters of a target alphabet, comprising the steps of:
providing a group of distinct sequential narrative media segments, each narrative media segment including a partial transliterated narrative text comprising words of a base language known to the student formed by base characters of a base alphabet, and wherein a number of target characters comprising a subset of the target alphabet are substituted in the text for corresponding base characters of the base alphabet, said sequential media segments containing successively increasing numbers of target characters of the target alphabet substituted for corresponding base characters of the base alphabet; and
displaying each narrative media segment to the student sequentially.

2. The method of claim 1 wherein the target characters substituted for base characters in a narrative media segment include the target letters substituted for base characters in a previous narrative media segment plus additional target characters.

3. The method of claim 2 wherein the number of additional target characters is about two or three.

4. The method of claim 1 wherein each distinct narrative media segment is contained on sheet material and wherein said display step comprises transferring the sheet material containing the media segment to the student.

5. The method of claim 1 wherein each distinct narrative media segment is electronically stored in a content database wherein said display step comprises transmitting the narrative media segment to a computer accessible to the student over a computer network.

6. The method of claim 5 wherein said display step further includes the teacher accessing a narrative media segment from the content database from a computer accessible to the teacher and transmitting the narrative media segment from the teacher-accessible computer to the student-accessible computer over the computer network.

7. The method of claim 6 wherein said display step further includes the step of the teacher and student sharing computer screens during transmission of the narrative media segment.

8. The method of claim 6 wherein said display step further includes the step of providing voice communication between the student and teacher during transmission of the narrative media segment.

9. The method of claim 1 wherein the subject matter of the partial transliterated text included in the sequential narrative media segments constitute a unitary theme or story.

10. The method of claim 1 wherein the base language is English.

11. The method of claim 1 wherein the target language is Hebrew.

12. The method of claim 1 wherein the base language is English and the target language is Hebrew.

13. The method of claim 1 wherein the number of base characters that remain after the substitution is chosen such that the reverse partial translated words are apparent to the student despite the substitution of the target characters.

14. The method of claim 1 including the additional steps of
providing a group of distinct sequential review/activity media segments corresponding to respective distinct sequential narrative media segments, each review/activity segment including partial transliterated words of the base language constituting at least one student activity, wherein a number of target characters corresponding to the target characters substituted in the text of a corresponding narrative media segment are substituted in the words constituting the at least one activity of a respective corresponding review/activity media segment; and
after displaying a particular narrative media segment to the student, and prior to displaying the next sequential narrative media segment to the student, displaying a review/activity media segment to the student which corresponds to the particular narrative media segment already displayed to the student.

15. Apparatus for teaching a student the pronunciation of target characters of a target alphabet, comprising:
a group of distinct sequential narrative media segments, each narrative media segment including a partial transliterated narrative text comprising words of a base language known to the student formed by base characters of a base alphabet, and wherein a number of target characters comprising a subset of the target alphabet are substituted in the text for corresponding base characters of the base alphabet;
wherein said sequential media segments contain successively increasing numbers of target characters of the target alphabet substituted for corresponding base characters of the base alphabet; and
a display for sequentially displaying the media segments to the student.

16. The apparatus of claim 15 wherein the target characters substituted for base characters in a narrative media segment include the target letters substituted for base characters in a previous narrative media segment plus additional target characters.

17. The apparatus of claim 16 wherein the number of additional target characters is about 2 or 3.

18. The apparatus of claim 15 wherein each distinct narrative media segment is contained on sheet material and wherein said display comprises the sheet material containing the media segment.

19. The apparatus of claim 15 further including a content database in which the group of distinct narrative media segments are electronically stored and wherein said display comprises a computer accessible to the student for receiving the narrative media segments transmitted over a computer network and displaying the narrative media segments to the student.

20. The apparatus of claim 19 wherein said apparatus further includes a computer accessible to the teacher for accessing the narrative media segments from the content database and transmitting the narrative media segments from the teacher-accessible computer to the student-accessible computer over the computer network.

21. The apparatus of claim 20 wherein the student- and teacher-accessible computers are programmed so that the teacher and student share computer screens during transmission of the narrative media segments.

22. The apparatus of claim 20 wherein the student- and teacher-accessible computers are programmed to provide voice communication between the student and teacher during transmission of the narrative media segments.

23. The apparatus of claim 15 wherein the subject matter of the partial transliterated text included in the sequential narrative media segments constitute a unitary theme or story.

24. The apparatus of claim 15 wherein the base language is English.

25. The apparatus of claim 15 wherein the target language is Hebrew.

26. The apparatus of claim 15 wherein the base language is English and the target language is Hebrew.

27. The apparatus of claim 15 wherein the number of base characters that remain after the substitution is chosen such that the reverse partial translated words are apparent to the student despite the substitution of the target characters.

28. The apparatus of claim 15 including
a group of distinct sequential review/activity media segments corresponding to respective distinct sequential narrative media segments, each review/activity media segment including partial transliterated words of the base language constituting at least one student activity, wherein a number of target characters corresponding to the target characters substituted in the text of a corresponding narrative media segment are substituted in the words constituting the at least one activity of a respective corresponding review/activity media segment; and
a display for displaying the review/activity media segments to the student.
